(19) United States
(12) Patent Application Publication
(10) Pub. No.: US 2008/0247843 A1
(43) Pub. Date: Oct. 9, 2008

(54) FASTENING SYSTEM

(76) Inventors: Robert J. Shluzas, New Smyrna, FL (US); Thomas E. Willcutt, Fayetteville, AR (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/052,779

(22) Filed: Mar. 21, 2008

Related U.S. Application Data
(60) Provisional application No. 60/920,098, filed on Mar. 26, 2007.

(51) Int. Cl. F16B 15/00; F16B 5/00

(52) U.S. Cl. 411/369; 403/408.1

(57) ABSTRACT

A fastening system including a fastener having a head, shank, and tip. The shank further includes a knurled section formed between the head and tip portions of the fastener. A washer made of a compressible material is applied over the tip of the fastener and tends to engage and compress against the head of the fastener as the fastener is driven into a sheet of material.

### CROSS REFERENCE TO RELATED APPLICATION

The present application claims the benefit of the priority of U.S. Provisional Application Ser. No. 60/920,098, filed Mar. 26, 2007.

### FIELD OF THE INVENTION

The present invention generally relates to fasteners. More specifically the present invention relates to a fastening system having a fastener and washer acting in combination for attachment of layers of sheet metal material.

### BACKGROUND OF THE INVENTION

There are a number of methods or systems for fastening or joining layers of metal materials or components together, including welding, brazing, gluing, screwing and pinning. In controlled environments, such as in industrial plants for manufacturing automobiles or other products, welding and brazing often are used to attach metal layers or components to provide advantageous strength and reduced component cost. In such controlled environments, the welding or brazing process can be automated so as to make it fast, clean, and efficient. However, for other applications, for example at outdoor construction sites, it generally becomes less efficient to weld or braze materials together, requiring significant labor and time, as well as requiring welding or brazing tanks, torches, and other materials that must be physically manipulated and carried by workers to the site(s) where they are needed.

Accordingly, for some applications, and in particular for low-stress applications where sheet materials are to be joined to other metal layers or materials, for example the application of a sheet metal cap to framing members or along a fire wall between adjacent apartment units, riveting, screwing, or pinning generally are the methods of choice for fastening such materials in the field. In these types of applications, it often is much easier and more efficient for a worker to apply screws, rivets, or pins that are driven into and through layers of material to be joined using tools such as electric or pneumatic screw drivers, drills, or hammers. In such applications, holes can be predrilled for the application of screws or bolts, or self-drilling screws can be used that form their own holes in the materials as they are driven therein, or the fasteners can be otherwise hammered or forced into the materials. From a labor and time perspective, however, pinning often can be more efficient for joining two materials together, since most automatic nailers can receive the pins on a belt or strip that are fed through the automatic nailer. Individual pins also can be placed within power drivers that use a 0.22 shell or shot cartridge for driving a nail or pin into or through the materials to be joined. Such shot driven power drivers further allow greater portability and use of the automatic nailers in a variety of situations and conditions.

A problem that exists, however, with pinning or using other types of driven fasteners for joining sheets of metal material, such as cold formed steel, is that often as a hole is punched in the metal by the fastener, the area around the hole through which the fastener typically is expanded as the pin passes therethrough and can become weakened. Further, the fastener can lose its grip with the metal as the metal and fastener are subjected to various stresses and extraordinary racking, as well as elemental effects such as wind and rain. Additionally, it is sometimes difficult to accurately and cleanly drive pins or similar fasteners into harder, more dense metal materials such as cold formed steel. As a result, the pin or other fastener can be stopped from penetrating all the way through the steel layers and thus will be prevented from achieving a tight engaging grip therewith.

Accordingly, it can be seen that a need exists for a fastening system that addresses the foregoing related and unrelated problems in the art.

### SUMMARY OF THE INVENTION

Briefly described, the present invention generally relates to a fastening system for joining metal layers or sheets, such as multiple layers of cold form steel, or to additional materials in stacked or overlapping arrangements. The fastening system of the present invention generally includes a pin type fastener having a shank or body that includes a first end and a second end. A head generally is formed at the first end, with the second end typically formed as a substantially conically shaped or pointed tip to facilitate driving of the fastener into both layers of metal or other materials. The shank further includes a knurled section formed along its length between its first and second ends.

A washer formed from a compressible material is mounted on the shank of the fastener. The washer generally is slip-fitted over the tip of the fastener shank and is formed from a compressible material such as a polymeric or synthetic material. The material of the washer has a hardness sufficient to enable the washer to be substantially compressed against the outer layer of materials being joined as the fastener is driven therethrough, while providing sufficient resilience to help enhance the engagement of the fastener shank with the metal layers being joined. The washer acts as a cushion or brake for the head of the fastener to limit overdriving of the fastener and further helps engage, seal, and otherwise hold the fastener in a fastened condition against the layers of material being joined.

Various features, objects and advantages of the present invention will become apparent to those skilled in the art upon a review of the following Detailed Description, when taken in conjunction with the accompanying drawings.

### BRIEF DESCRIPTION OF THE DRAWINGS

FIG. 1 is a perspective view illustrating the fastening system of the present invention for attaching or joining sheets of metal materials.

FIG. 2 is an end view of the compressible washer of the present invention.

FIG. 3 is a perspective view of the fastener of the invention shown in FIG. 1.

FIGS. 4A and 4B are side elevational views illustrating the operation of the fastening system of the present invention.

### DETAILED DESCRIPTION

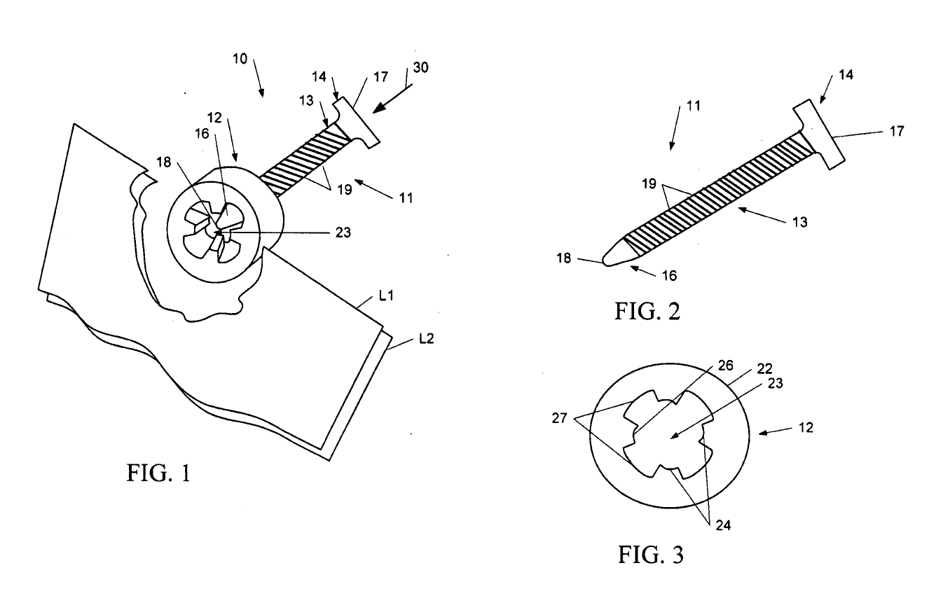

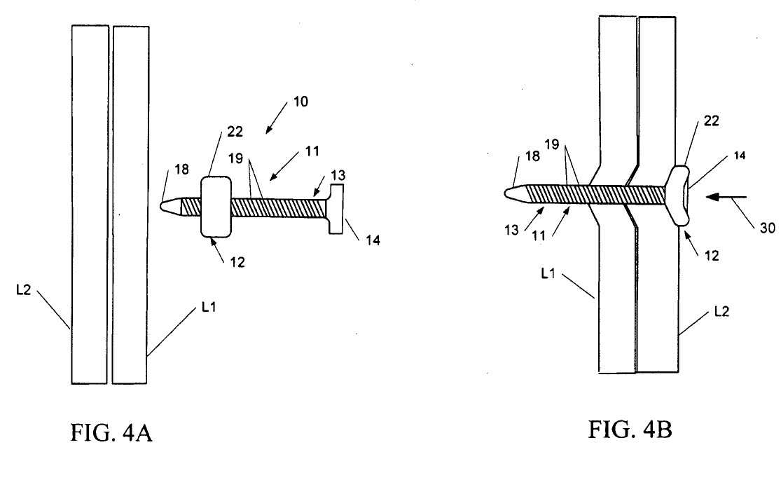

Referring now to the drawings in which like numerals indicate like parts throughout the several views, FIGS. 1-4B generally illustrate the fastening system 10 in accordance with one example embodiment of the present invention. As indicated in FIG. 1, the fastening system 10 of the present invention generally is designed for attaching layers or sheets of materials (shown as layers L1 and L2 in FIGS. 1, 4A and 4B), such as metal or synthetic materials having significant hardness. For example, the fastening system of the present invention has particular applicability to fastening operations involving the joining of layers of cold formed steel or similar hard material layers having gauges ranging from approximately 10 gauge through approximately 24 gauge. It also will be understood, however, that other, similar materials in multiple layers and gauges and hardnesses also can be attached using the fastening system of the present invention.

As illustrated in FIG. 1, the fastening system 10 generally includes a fastener 11, here shown as a pin, and a washer 12 received in an engaging arrangement along the fastener 11. The fastener typically will be a pin, screw, or similar fastener, and in particular can include a drive pin such as taught in U.S. Pat. No. 6,805,525, the disclosure of which is incorporated fully herein by reference. As illustrated in FIGS. 1 and 2, the fastener 11 includes an elongated body or shank 13 having first and second ends 14 and 16, respectively. A head portion 17 generally is formed at the first end 14 of the fastener shank 13, while the second end 16 of the fastener shank generally includes a generally conically shaped or pointed tip 18 to facilitate the fastener puncturing and passing through the material layers during use. As additionally shown in FIGS. 1 and 2, the head portion 17 of the fastener 11 is illustrated with a substantially flat appearance. It will, however, be understood by those skilled in the art that the fastener could also be provided with a variety of different type head designs, including recessed, flanged and/or countersunk head designs for use in varying applications.

The fastener 11 can be formed in a variety of different lengths and diameters to fit a variety of different applications, and generally is formed from a metal such as steel or other hard, durable metal, which can be heat treated or tempered to enhance its strength, or can be formed from a composite or synthetic material generally having sufficient strength so as to be able to penetrate hardened materials such as cold formed steel. For example, the fastener typically can range in length from about ¾ inch to about 2½ inch and from about 0.10 inches to about 0.20 inches in diameter, which the tip 18 having an angle or point of about 8° to 15° or more, as needed. It also will be understood, however, that fasteners with greater or lesser lengths and diameters and having pointed or more rounded tips also can be used depending on the application and materials for which the fastener system 10 is to be used. The fastener also can be coated or treated, such as by electroplating with zinc or other similar coatings or treatments, to provide the fastener with improved corrosion resistance and/or wear.

The fastener 11 further includes a knurled or threaded section 19, including a series of adjacent spiral grooves, as illustrated in FIGS. 1 and 2. The knurled portion 19 extends substantially along a midsection or intermediate portion of the fastener shank 13 between the head and pointed end thereof. The threads or grooves forming the knurled section 19 of the fastener 11 are formed with a thickness and spacing so as to generally assist in the driving of the fastener through the material sheets L1 and L2 (FIG. 1), by causing a portion of the force imparted to the fastener as it is driven through the layers L1 and L2 to be converted from linear to rotary motion. This enables the threads to cut into and through the layers and to help form additional points of contact or engagement to help hold the fastener in its position driven into and joining the layers.

As indicated in FIGS. 1, 3, and 4A-4B, the washer 12 is mounted over the tip of the fastener 11, generally being positioned along the shank of the fastener adjacent the second end 16 thereof. The washer 12 also generally has a substantially cylindrical washer body 21 that typically is formed from a compressible material. One example material utilized for the washer 12 can be a polypropylene or nylon material having a durometer hardness of approximately 65-70 durometer up to approximately 90-95 durometer. Alternatively, other composite or synthetic materials having a hardness or compressibility within a similar range of durometer harnesses also can be used. Still further metal washers also could be used, but the metal material used for the washer generally should be malleable enough to allow the desired compression of the washer while also providing sufficient resistance and/or engagement in between the fastener and material layers L1/L2 after the fastener has been inserted/driven into the material layers being joined. Regardless of whether the washer material is metallic or non-metallic, electro-chemical compatibility should be maintained in selection of materials therefore.

The washer body 21 generally can have a thickness of approximately 0.1-0.125 inches up to approximately 0.150-0.20 inches, although it also will be understood that the thickness of the washer body further can be varied, i.e., increased or decreased in accordance with the size of the fastener being used for a particular application. The washer type and thickness further can be varied to maximize the holding power between the washer, fastener, and various base materials. The outer diameter of the washer also is designed to substantially maximize the fastener's drivability using various installation tools. The body 21 of the washer 12 further generally has an outer diameter of approximately 0.250 inches-0.30 inches, although the washer body further can be formed with larger or smaller outer diameters as needed, depending upon the size of the fastener shank 13 with which the washer is being used and its location. A fastener opening 23 generally is defined approximately though the center of the washer body 21 for receiving the shank 13 of the fastener 11 therethrough, as indicated in FIGS. 1 and 4A. The outer or first diameter of the fastener opening 23 (FIG. 3) also can be varied as needed to accommodate the diameter of the fastener with which the washer is being utilized. For example, for a fastener having a diameter of approximately 0.090-0.10 inches, the fastener opening of the washer can be approximately 0.045-0.060 inches, although further variations also can be provided as needed to ensure a snug, frictionally engaging fit with the shank of the fastener that is driven therethrough.

As further illustrated in FIGS. 1 and 3, a series of wings or projections 24 extend toward the center of the washer, projecting into the fastener opening, forming a webbing for engaging the shank of the fastener. The wings or projections 24 are shown in FIG. 3 as having a substantially square, rectangular, or trapezoidally shaped construction, although other, different shapes can be utilized, including but not limited to prismatic or parallelpiped shapes. Further, the wings or projections and can have substantially arcuate or curved inwardly facing surfaces 26 adapted to bear and seal against the shank of the fastener. In one preferred embodiment, the minimum number of wings or projections a washer will have would be four wings, equally spaced around the circumference of the washer. However, there may be instances when fewer or more than four wings or projections might be desired. The inwardly facing surfaces of the projections 24 thus define a second or inner diameter of the fastener opening that can be approximately equivalent to the diameter of the fastener shank as needed or desired.

The projections 24 further define recesses 27 therebetween along the first or outer diameter of the fastener opening 23. As the fastener 11 is driven through the washer, it urges the projections 24 therealong so as to form a gripping engagement between the washer and the shank fastener. The inside diameter of the projections 24 or webbing created thereby further enables installation of the washer 12 over a wide range of fastener shank diameters, while the outer diameter of the washer generally is selected so as to be sufficient to substantially stay within the outer diameter of the fastener head.

In use, such as illustrated in FIGS. 1, 4A and 4B, the washer 12 initially is placed over the pointed tip end 18 of the fastener shank 13, typically during a collation process prior to being loaded within a tool such as a pneumatic, electric, or shot driven driver or similar tool. The position of the washer adjacent the tip of the fastener helps act as a guide or cushion as the fastener is initially driven into and through the layers L1 and L2 of cold-formed steel or similar materials being joined. As indicated in FIG. 4B, as the fastener is driven in the direction of arrows 30, it pulls and joins the sheets of material L1 and L2 together, while at the same time, the webbing or projections 24 of the washer 12 tend to bend and move with the shank of the fastener as the faster is driven through the layers.

As the head 17 of the fastener 11 approaches the outer layer 12 of materials being joined, the washer 12 is compressed between the head 17 and the outer layer of the materials being joined so as to act as a cushion or break for the head to limit overdriving of the fastener through the outer layer of material. The compression of the washer further causes it to bear or lock against the shank of the fastener and to be at least partially forced into the opening in the top layer of materials being joined created by the driving of the fastener therethrough. As a result, the fastener 11 and washer acting in combination helps create a further bond between the fastener and the layers of material L1 and L2 being joined so as to minimize or resist the fastener becoming loosened or otherwise dislodged when subjected to stresses such as movement of the metal sheets after they have been joined, etc. Furthermore, the interference fit between the fastener and the washer wings and the proper selection of wing geometry help cause the wings to effectively deform in the direction of fastener insertion, as well as compress against the fastener and outer material layer, enhancing the fit between the fastener, washer, and material layers.

The combination of the compressible washer 12 and fastener 11 of the fastening system 10 according to the present invention accordingly provides the ability to fasten or join multiple (at least two and in some cases more than two) layers of relatively harder, more dense materials such as cold formed steel having varying thicknesses in ranges of approximately 10 gauge to at least approximately 24 gauge. In addition, the fastening system of the present invention further can be used for attaching sheets of steel ranging from approximately 3/16 of an inch or less, up to approximately 5/16- 7/16 of an inch or more depending on the fastener size. The compression and engagement of the washer and its webbing with the shank of the fastener as it is driven through the outer layer of material further provides increased or enhanced withdrawal and sheer values for the connection thus being formed between the sheets of materials.

It will be understood by those skilled in the art that while the foregoing has been described with reference to preferred embodiments and features, various modifications, variations, changes and additions can be made thereto without departing from the spirit and scope of the invention.

What is claimed:

1. A fastening system for joining multiple layers of materials, comprising:
a fastener having a shank including a first end, a second end forming a tip and a knurled or smooth section extending between said first and second ends; and
a washer applied to said fastener over said tip and having a body formed from a deformable material having a hardness sufficient to enable said washer to substantially compress against an outer layer of the materials being joined so as to provide additional resistance between said fastener and the materials being joined and to retard over driving of said fastener through the outer layer of materials.

2. The fastener system of claim 1 and wherein said washer further comprises a fastener opening formed approximately centrally within said washer body and adapted to receive said shank of said fastener therethrough.

3. The fastening system of claim 2 and wherein said fastener opening further compresses a series of projections that extend inwardly and engage said shank of said fastener in frictional engagement.

4. The fastening system of claim 1 and wherein said tip of said fastener is formed in a pointed, conical shape.

5. The fastening system of claim 1 and wherein said second end of said fastener shank comprises a flattened head having a diameter greater than a diameter of said shank.

6. The fastening system of claim 1 and wherein said deformable material of said washer has a durometer hardness of about 70-90 Durometer.

7. The method as claimed in claim 13 and wherein the shank has a diameter in the range of 0.10 inches to 0.20 inches and the shank has a shank length in the range of 0.75 inches to 3.0 inches.

8. A system for joining sheets of cold formed steel, comprising:
a fastener having:
a head;
a shank extending from said head to a pointed tip and having a knurled or smooth section formed therealong; and
a washer formed from a deformable material having a hardness sufficient to enable said washer body to be compressed between a sheet of a sheet being joined to cushion said head of the fastener thereagainst;
wherein said washer includes a fastener opening for receiving said shank through said washer, and a series of inwardly extending projections adapted to engage and bear against said shank to enable said washer to be used with fasteners having varying sized shanks.

9. The fastener of claim 8 and wherein said deformable material of said washer has a durometer hardness of about 70-90 Durometer.

10. The fastener of claim 8 and further comprising at least two approximately square shaped projections.

11. The fastener of claim 8 and wherein said washer has a thickness of at least approximately 0.10 inches.

12. The fastener of claim 8 and wherein said fastener opening has a first diameter, and wherein said inwardly extending projections define a second diameter smaller than said first diameter.

13. The fastener of claim 12 and wherein said second diameter is smaller than said first diameter by approximately 0.010-0.030 inches.

14. A method of fastening a plurality of material layers, the method comprising:
providing a fastener, comprising:
a head and a cylindrical shank extending from the head to a pointed tip and having a knurled section formed therealong;
placing the shank of the fastener into contact with a washer, the washer comprising a body formed from a deformable material having a hardness sufficient to enable a portion of the washer to compress against an outer layer of the material layers being joined to provide additional resistance between the fastener and the materials being joined;
inserting the fastener through the washer and into the material layers causing the material layers to be joined; and
deforming the washer against the outer material layer as the fastener is inserted therethrough to an extent sufficient to retard over driving of the fastener through the outer layer of material.

15. The method as claimed in claim 14 and wherein the washer further comprises at least two inwardly extending shaped projections having an approximate shape, selected from the group of shapes consisting of: a square, a rectangular, prismatic, trapezoidal, and combinations thereof.

16. The method as claimed in claim 15 and wherein the shaped projections are inwardly extending shaped projections that deform to engage the shank during insertion of the shank through the washer.

17. The method as claimed in claim 16 and wherein said washer has a central opening having a first diameter, and the inwardly extending projections define a second diameter smaller than the first diameter such that an interference fit is created between the fastener and the washer.
